(19) United States
(12) Patent Application Publication
(10) Pub. No.: US 2019/0019054 A1
(43) Pub. Date: Jan. 17, 2019

(54) Contact Information Identification System

(71) Applicant: Eugene Waxman, East Northport, NY (US)

(72) Inventor: Eugene Waxman, East Northport, NY (US)

(21) Appl. No.: 15/647,189

(22) Filed: Jul. 11, 2017

(51) Int. Cl. G06K 9/34; G06F 17/30; G06K 9/20; G06F 17/27; G06K 9/62

(52) U.S. Cl. CPC G06K 9/344; G06F 17/30707; G06F 17/30675; G06F 3/0482; G06F 17/2705; G06K 9/6202; G06K 9/2081

(57) ABSTRACT

A contact information identification system, has the steps of a user selecting content from the display, the system scanning the content with and images with optical character recognition, to produce text, the system parses the text, the system groups text according to a factor selected from the group consisting of proximity of words, line or section, or by matching key words, to form a group, the system matching the group to a data field, the data associated with each field is presented in a list configured for correction by a user, and fields may be deleted by a user if they do not form part of the contact information or are not relevant to the contact information.

### BACKGROUND OF THE INVENTION

### 1. Field of Invention

The present invention relates to the field of a system for parsing and identifying contact information for insertion into a contact management system, or other contact or lead-collecting data constructs.

### 2. Description of Related Art

Contact information is typically stored online in web pages and directories as text. Although it has a typical order, with name as the first line, company name next, and address in the two or three lines after that, with an optional phone number or email appearing after that, for the most part contact information is not standardized and is not accessible in the same way in different cases. The contact information may appear in the form of text or as a graphic, and while fields may have similarities, there are also a number of different format, especially when international formats are considered.

For ease of use, contact information may be easier to access if placed within a contact database. To insert contact information gleaned from the web, mobile sources, desktop, documents, or other data source into a contact database, it is typically necessary to cut and paste the information, field by field, from the contact data on the webpage or directory. This is an error-prone and time-consuming process. Certain files are identified as containing contact information, such as a vCard or .vcf file, which is recognized by contact management systems as a contact's information, wherein the fields are identified with field codes such that the contact management system knows the correct placement of the contact data. There are other formats as well that may be added.

There are no systems for free-form contact information on the web or within directories to be identified and classified according to the type of data, wherein they may be easily and automatically inserted into the contact management system. Most frequently, the data is seen and characterized by a human operator. Currently, no app-based solutions exist. This may be due, in part, to processors on the mobile device operating too slow as these apps require a large amount of logic to be in place. It is possible to call to a server, or utilize API in order to speed up the process; however, this is not currently in use with existing services.

Based on the foregoing, there is a need in the art for a system that interprets contact information and categorizes it correctly into fields that match with the data of the contact information, such that the data is correctly matched with the field name and the contact information is consequently easily used within the contact management system or for other applications such as Salesforce or other lead systems.

### SUMMARY OF THE INVENTION

A contact information identification system, operates according to the steps of a user selecting content from the display, the system scanning the content with and images with optical character recognition, to produce text, the system parses the text, the system groups text according to a factor selected from the group consisting of proximity of words, line or section, or by matching key words, to form a group, the system matching the group to a data field, the data associated with each field is presented in a list configured for correction by a user, and fields may be deleted by a user if they do not form part of the contact information or are not relevant to the contact information.

The contact information identification system further comprising the steps of a user selecting contact information, the system parsing the text, and comparing to and learning from a database of known text, the system recognizing a set of numbers followed by a series of words, identifying states based on a listing of full state names or abbreviations contained in a database, the system consulting a database of known surnames, wherein the system recognizes the given name based on its proximity to the surname, the system recognizing a qualification occurring after the name, and the system parsing the contact information into a correct location.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1A is a flowchart of the use of the system, according to an embodiment of the present invention;

FIG. 1B is a flowchart of the use of the system, according to an embodiment of the present invention; and

FIG. 2 is a flowchart of the parsing algorithm, according to an embodiment of the present invention.

### DETAILED DESCRIPTION OF PREFERRED EMBODIMENTS

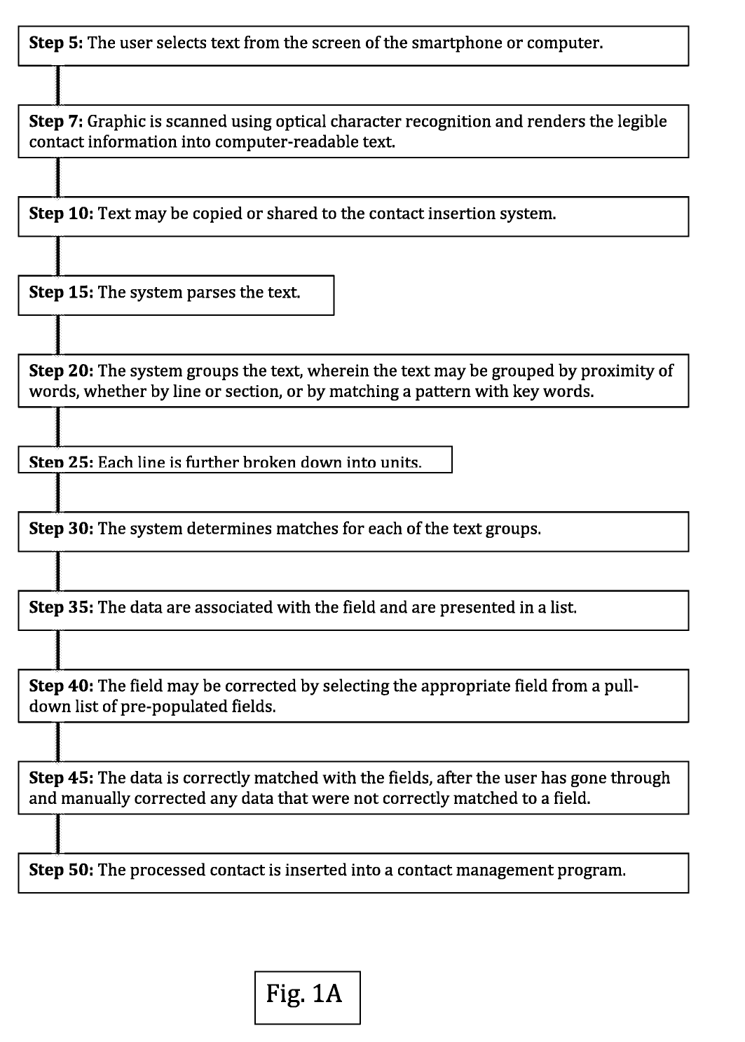

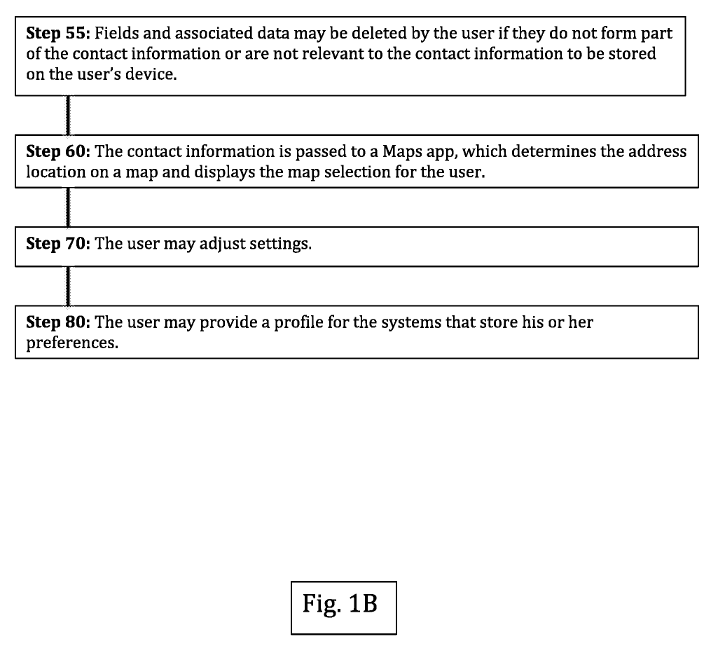

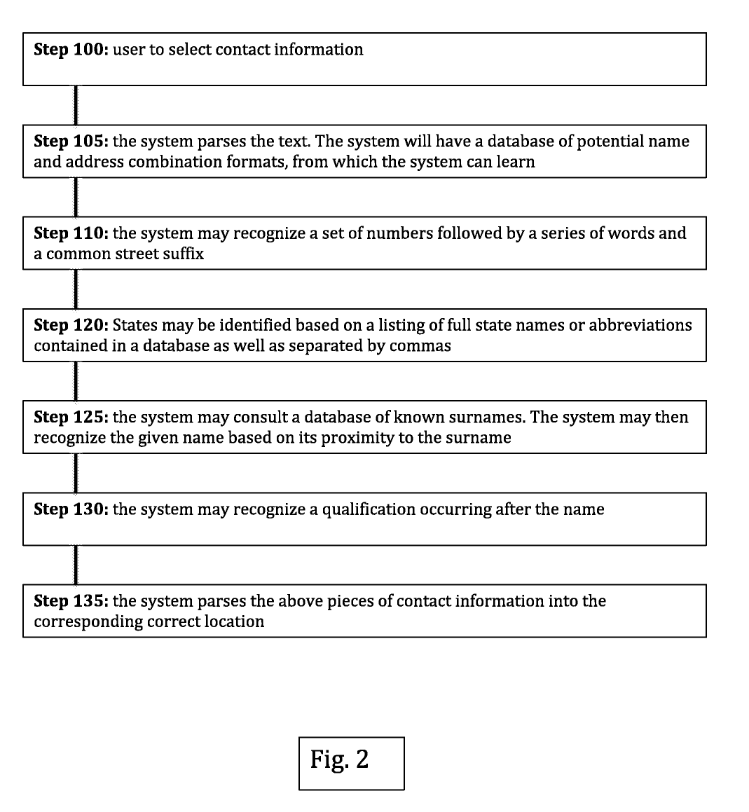

Preferred embodiments of the present invention and their advantages may be understood by referring to FIGS. 1-2, wherein like reference numerals refer to like elements. In a high level overview, the method has several steps, wherein the first step comprises splitting the data into rows, which may be performed on any of the following characters found in the text, “tab, line break, pipe sign |, [space], period or comma”. In the second step, the row of data is then sent into the scanning algorithm, where the process identifies the rows by passing the rows through different comparison procedures to identify which row contains a company name, which row contains person names, which row contains a street address, city state zip and country. In this way the identification of the phone number containing rows, fax number, web and email containing rows is all processed and identified—separated into their own second bucket algorithms for that specific piece of data. In the third step, identified rows are passed through the second tier algorithm to identify what exactly they are and how to have those setup and added to the identified contact field. In the fourth step, a graphical interface of rendered fields is generated and shown on the screen and also the non-recognized data is also shown in this stage. This information then allows human processing of any further data and the identification of fields misidentified or non-identified and can be sent along to support to be noted and added later on to be recognized in the future. Entering manual modifications is partially built-in. In a fifth step, the user has the option to do multiple things at the end such as save the added-to device contacts database. The contacts may take the place of CRM data, text, email. Additional modules will be added for sex, identity, and address verification. The company URL may be provided for further verification.

In reference to FIG. 1, in step 6, the user selects text from the screen of the smartphone or computer. The text may be derived from online resources, electronic documents, images, physical documents, or any other medium where information is stored and displayed. The text may be selected from content such as a webpage or a text file, and the text may be selected by a copy mechanism or other text selection mechanisms known in the art. Optionally, in step 7 a graphic is scanned using optical character recognition and renders the legible contact information into computer-readable text (such as ASCII). In an embodiment, the user highlights the portion of graphics that is being used, by drawing a box around it, for example. The text is selected as text characters, and may be copied or shared to the contact insertion system at step 10. In an embodiment, a one-click copy/share option may be available. The text may include information such as but not limited to name, title, address, phone number, company name, social media account details, Skype name, title, or any other identification data. In step 15, the system parses the text, separating sentences and recognizing punctuation as well as truncation and abbreviation. Then the sentences are each scanned to determine if it is part of an address and, if so, data both ‘in front of’ and ‘behind’ it are rescanned to determine if they are also part of the address where they are not already identified as such. This is particularly useful in determining company names as there may be exponential combinations of names and thus, identifying a street address after it can help determine the extent of the company name. As such the company name is attempted to be identified and confirmed later in the algorithm.

In step 20 groups the text, wherein the text may be grouped by proximity of words, whether by line or section, or by matching a pattern with key words. In a multiple-line selection, the algorithm may infer that the first line is the name. The second line may be a company name. The third line may be a street address, a fourth line may include the City, State and ZIP, the fifth line may be a website or phone number. An algorithm may be helpful in determining the content of each line. For example, a number followed by a name and a common roadway indicator such as “St.”, “Rd.”, “Street” or “Road”, may indicate a street address, while one or two words followed by a couple of capitals matching with a delimited list of States, followed by a five-digit number indicating a ZIP code, would indicate that the data being parsed is the second line in the address. In an embodiment, the street line algorithm looks for known variations of ZIP and ZIP+4, and also known cities and states (and abbreviations) from a large city/state database. Zips or postal codes can be further checked against postal service databases known zip codes and street addresses can be confirmed the same way, when applicable and depending on the information and status of the address requestor. City—State—ZIP sequences are looked for, identified and parsed into their appropriate fields and an enormous number of variations can be recognized.

In step 25 each line is further broken down into units. Taking the name line, for example (first line), each of the “words” may be separated by spaces. The first word may be a title, such as Mr., Dr. and is easily characterized by terminating in “.”. The next word may be the first name, and the one after that is the last name. There may be a further title or qualification after the name, such as “M.D.” or “Esq.”, also notable for terminating in a zero. In the address, a leading number would indicate a street number, and a tailing roadway indicator would lead the system to characterize the words in the middle as the street name. In this way each of the words (separated by spaces) may receive a context characterization such as name or street, and may also be further broken down depending on the position in the line and the recognized terms such as titles or a common roadway indicator. In some cases the line location is used to inform the field, for example, if a character combination that appears to be a state appears on the first line after a name, the character combination may be taken to be a qualification MD (Medical Doctor) rather than the state MD (Maryland).

In step 30 the system determines matches for each of the text groups. Where unsure, the system provides intelligent guessing as to what the field may be, based on confluence of known factors. Intelligent guessing may be derived from an error log. For example, a user may encounter an error and submit this error along with a correction to the server. As errors are collected and logged from the community of users, commonalities may occur allowing for an automatic suggestion or correction of the error. In step 35 the data are associated with the field and are presented in a list, wherein data is editable, and associated with a field. The user is able to click on information present in the list and edit or delete data. This change in data may be logged as described in step 30 in order to enhance the community based learning of the algorithm. In step 40 the field may be corrected by selecting the appropriate field from a pull-down list of pre-populated fields.

In step 45, the data is correctly matched with the fields, after the user has gone through and manually corrected any data that were not correctly matched to a field. In step 50 the processed contact is inserted into a contact management program, wherein the field identification matches with the contact management program's pre-determined field list. In step 55 fields and associated data may be deleted by the user if they do not form part of the contact information or are not relevant to the contact information to be stored on the user's device.

In step 60 the contact information is used to create a v-card, wherein the v-card has the ability to be emailed, texted, or in some way sent to another person. The v-card may be used to call, text, email, or in any way contact the entity that is embodied by the v-card. The information may also be chosen to be appended to existing contacts. Also integrate to push into Salesforce and other popular CRMs.

In an embodiment, contact data collected by the user may be sent to a map, allowing for the user to visualize the location along with other contact details.

In an embodiment, in step 70, the user may adjust settings wherein a basic and advanced versions of the system. The basic mode limits the elements it will search to basic and essential contact elements, while the advanced option will contain additional search elements beyond the essential contact information. Basic functions will inherently result in faster operational speeds when compared to the advanced mode.

In step 80, the user may provide a profile for the systems that stores his or her preferences. In an embodiment, the user will be able to choose a service option such as basic or premium, each of which offering a variety of setting to configure the experience of the user. As the user operates within the system, changes made as well as errors are logged. As the community recognizes errors, the algorithm may be altered to correct the error or use machine learning to improve itself. This community data will help teach the developers what was overloaded in development. For example, a correction made can be logged, and based on the frequency of the change being made the system can decide that a piece of data selected by the algorithm is in fact a different datum according to common user corrections.

Graphics may also be selected as containing contact data wherein a character-recognition procedure is carried out to convert the graphics to text, which may then be parsed to determine the appropriate fields for the data. Graphics conversion to text uses optical character recognition to determine text (or probably text) from a graphics file. There are several open-source OCR engines available that we use to break an image into text and sentences. An example of one such engine used is Tesseract, which is helped and maintained by both Google and the user community as an open-source OCR engine and is widely respected and acclaimed for it's accuracy.

The parsing algorithms may be statistical based on a previously-determined frequency of combinations, such that, when unsure, the algorithm bases its determination on a statistical frequency for the combination occurring together and within the characterization (name, address etc.) of the field. In an embodiment the algorithm relies on statistically significant commonalities amongst user submissions of corrections and manual reviews. The modified statistical P-value will be determined by backtesting data after manual review and comparing it to known addresses to see what choices are working best and avoid statistical Type I and Type II errors. The backtesting will be key and will help improve modifications to the algorithms.

In reference to FIG. 2, an algorithm for identifying a name and address is described in an embodiment of the present invention.

In use, Step 100 requires the user to select contact information such as John Doe, MD, Doe Endocrinology Center, 1234 Main St, San Diego Calif. 92014. In Step 105, the system parses the text. In order to achieve this, the system will have a large database of potential name and address combination formats, from which the system can learn. In Step 110, the system may recognize a set of numbers followed by a series of words and a common street suffix. The system will then identify this set of data as an address. In order to achieve this, the system will have a large database of components such as street suffixes to identify street names. In the above example, it is possible that “St” could also be listed as Street, St., St, st., or st, resulting in the need for the system to recognize each of these scenarios as one and the same. This would be needed for abbreviations and case variations of Drive, Boulevard, and any other common suffixes referencing streets.

In Step 120, States may be identified based on a listing of full state names or abbreviations contained in a database as well as separated by commas. States are then typically followed by a series of five numbers, which denote the ZIP code of the address. In an embodiment, the address verification starts with the ZIP code which provides a number of legitimate street names for verification within the ZIP. The use of a ZIP code, as it's numeric, also significantly speeds up searching and placement within the database.

In Step 125, the system may consult a database of known surnames Once a surname is referenced the system may then recognize the given name based on its proximity to the surname. The algorithm may learn popular surnames as the community of users sends in more data. In step 130, the system may recognize a qualification occurring after the name. In this case MD may either denote a medical doctor or the state of Maryland. In this case the qualification of medical doctor (MD) occurring after the surname will inform the system that this is in fact a qualification and not the state of Maryland.

In step 135, the system parses the above pieces of contact information into the corresponding correct location. Various parsing methods may be used as known in the art.

### Examples

In the US example, an address may follow this pattern:

### COMPANY NAME

### Person Name

### STREET ADDRESS 1

### STREET ADDRESS 2

### City, ST ZIPCODE

However, the version for CHINA (in English) looks at addresses some of which may follow the following pattern:

### COMPANY NAME

### STREET ADDRESS 2

### STREET ADDRESS 1

### CITY

### POSTAL CODE (6 DIGITS)

There are nuances in the address information, and the system learns by comparing a list of street names and person names in Chinese to follow the same parsing patterns that will become the Chinese version. This holds true for all countries—first run may be in English, such that the system learns and applies these rules to enable Chinese to be converted to actual Chinese dialect as a stage 2 for that.

Note that the foregoing embodiments are contemplated as being used with a variety of languages and even a mix of different languages. These languages include, but are not limited to English, French, German, Spanish, Chinese.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NTT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims:

I claim:

1. A contact information identification system, operable to perform the steps comprising:
a. receiving content, selected by a user from a display;
b. scanning the content using optical character recognition, to produce text;
c. parsing the text;
d. grouping the text according to a factor selected from a group consisting of proximity of words, line, section, matching key words, and a combination thereof;
e. matching the group to a data field;
f. configuring the data associated with each field for presentation to a user; and
g. receiving data corrections from the user.

2. The contact information identification system of claim 1, further operable to perform the steps comprising:
parsing the text, and comparing the parsed text with text from a database of known text; and
parsing the contact information into a correct location.

3. The contact information identification system of claim 1, further operable to perform the steps comprising:
recognizing a set of numbers followed by a series of words; and
parsing the contact information into a correct location.

4. The contact information identification system of claim 1, further operable to perform the steps comprising:
identifying states based on a listing of full state names or abbreviations contained in a database; and
parsing the contact information into a correct location.

5. The contact information identification system of claim 1, further operable to perform the steps comprising:
consulting a database of known surnames, wherein the system recognizes a given name based on its proximity to the surname; and
parsing the contact information into a correct location.

6. The contact information identification system of claim 1, further operable to perform the steps comprising:
recognizing a qualification occurring after the name; and
parsing the contact information into a correct location.

7. The contact information identification system of claim 1 wherein the text is from a language selected from a group of languages consisting of English, French, German, Spanish, Chinese or a combination thereof.

8. The contact information identification system of claim 1 further comprising placing selected text in a V-card.

9. A computer-readable, non-transitory programmable product, for transmitting contact information, comprising code executable by one or more processors, to cause the one or more processors to do the following:
a. receive content, selected by a user from a display;
b. scan the content using optical character recognition, to produce text;
c. parse the text;
d. group the text according to a factor selected from a group consisting of proximity of words, line, section, matching key words, and a combination thereof;
e. match the group to a data field;
f. configure the data associated with each field for presentation in to a user; and
g. receive data corrections from the user.

10. The computer-readable, non-transitory programmable product as recited in claim 9 further causing cause the one or more processors to do the following:
parse the text, and comparing the parsed text with text from a database of known text; and
parsing the contact information into a correct location.

11. The computer-readable, non-transitory programmable product as recited in claim 9 further causing cause the one or more processors to do the following:
recognize a set of numbers followed by a series of words; and
parse the contact information into a correct location.

12. The computer-readable, non-transitory programmable product as recited in claim 9 further causing cause the one or more processors to do the following:
identify states based on a listing of full state names or abbreviations contained in a database; and
parse the contact information into a correct location.

13. The computer-readable, non-transitory programmable product as recited in claim 9 further causing cause the one or more processors to do the following:
consult a database of known surnames, wherein the system recognizes a given name based on its proximity to the surname; and
parse the contact information into a correct location.

14. The computer-readable, non-transitory programmable product as recited in claim 9 further causing cause the one or more processors to do the following:
recognize a qualification occurring after the name; and
parse the contact information into a correct location.

15. The computer-readable, non-transitory programmable product as recited in claim 9 wherein the text is from a language selected from a group of languages consisting of English, French, German, Spanish, Chinese or a combination thereof.

16. The computer-readable, non-transitory programmable product as recited in claim 9 further comprising code executable by one or more processors, to cause the one or more processors to place selected text in a V-card.
